(19) United States
(12) Patent Application Publication
(10) Pub. No.: US 2016/0343144 A1
(43) Pub. Date: Nov. 24, 2016

(54) METHOD OF DETECTING VEHICLE, DATABASE STRUCTURE FOR DETECTING VEHICLE, AND METHOD OF ESTABLISHING DATABASE FOR DETECTING VEHICLE

(71) Applicant: GWANGJU INSTITUTE OF SCIENCE AND TECHNOLOGY, Gwangju (KR)

(72) Inventors: Seung Jong NO, Gwangju (KR); Moon Gu JEON, Gwangju (KR)

(21) Appl. No.: 14/890,900

(22) PCT Filed: Jan. 26, 2015
(86) PCT No.: PCT/KR2015/000798

§ 371 Date: Nov. 12, 2015

(30) Foreign Application Priority Data
Dec. 30, 2014 (KR) 10-2014-0193533

(51) Int. Cl. G06T 7/20; G06F 17/30; G06K 9/62

(52) U.S. Cl. CPC G06T 7/204; G06K 9/6202; G06K 9/6269; G06K 9/6218; G06K 9/6256; G06T 7/2046; G06F 17/30256; G06F 17/30271; G06T 2207/30252; G06T 2207/20144; G06T 2207/30241; G06T 2207/10016

(57) ABSTRACT

A database structure for detecting a vehicle includes a first database, in which a semantic region model is stored in connection with pixel locations in an image as a region that a moving object is located; and a second database, in which size templates for obtaining a sub-image of the moving object to be compared to information stored in a classifier are stored in correspondence to the semantic region model. According to the present disclosure, an automated method of inexpensively, quickly, and accurately detecting a vehicle with a small amount of calculations may be provided.

### BACKGROUND

1. Technical Field

The present disclosure relates to a method of detecting a vehicle, and more particularly, to a method of detecting a vehicle, a database structure for detecting a vehicle that is required for implementing the method of detecting a vehicle, and a method of establishing a database for detecting a vehicle for providing the database structure for detecting a vehicle.

2. Description of the Related Art

Detection of vehicles running on roads may be applied for vehicle identification, traffic amount analysis, and stolen vehicle recognition. The vehicle detection is commonly performed by using a closed-circuit TV installed at roadside. Of course, vehicle detection may also be performed in various other manners, and it should be understood that the vehicle detections performed in the other manners are also included in the technical spirit of the present disclosure. In the related art, a method of detecting a vehicle is a method that a person observes an input video obtained via a closed-circuit TV as described above by the naked eyes. Since such a method relies on human capability, it is difficult to secure sufficient accuracy and is expensive.

Therefore, a method of semi-automatically detecting a vehicle by analyzing an image captured from input video picked up by a closed-circuit TV has been suggested.

For example, a classical sliding-window method is known in the art. For example, “A trainable system for object detection” (C. Papageorgiou and T. Poggio, IJCV, Vol.38, pp.15-33, 2000) and “Finding People in Images and Videos” (N. Dalal, Ph.D thesis, Institute National Polytechnique de Grenoble, 2006) disclose detailed operations related to the same. In the classical sliding-window method, an image corresponding to a particular time point is obtained from an input video, and a partial image of a region including a vehicle is obtained from the image. Next, a sliding-window is located on the obtained partial image and a sub-image within a region inside the sliding-window is extracted. Finally, a matching score of the sub-image is calculated by comparing the sub-image to a classifier. The classifier stores information regarding respective vehicles in a particular format. A result of detecting a vehicle is determined based on the matching score.

If there is difference between aspect ratios of the partial images, a detection of a vehicle may likely fail by using the classical sliding-window method. In other words, if an aspect ratio of a sliding-window is different from an aspect ratio of an image learned by a classifier, detection of another vehicle fails. Furthermore, since the sub-image is extracted with respect to the entire partial image while moving a sliding-window and the operation is continuously performed while changing scale of the partial image, a large amount of calculations is required, and an operation speed becomes slower as the amount of calculation increases.

To resolve the problems, a scene-specific sliding-window method is known in the art. For example, the “Attribute-based vehicle search in crowded surveillance videos” (R. Feris, B. Siddiquie, Y. Zhai, J. Petterson, L. Brown, and S. Pankanti, Proc. ICMR, 2011) and the “Large-scale vehicle detection, indexing, and search in urban surveillance videos” (R. Feris, B. Siddiquie, J. Petterson, Y. Zhai, A. Datta, L. Brown, and S. Pankanti, Tran. Multimedia, Vol.14, pp.28-42, 2012) disclose the detailed descriptions of the method. In the scene-specific sliding-window method, a plurality of sliding-windows for performing the classical sliding-window method is provided by shape and size.

However, a problem of the scene-specific is that an amount of calculations increases as a number of the sliding-windows increases. For example, if three sliding-window are provided, a required amount of calculations becomes 3 times greater than that required by the classical sliding-window method providing one sliding-window, and an operation speed become slow in correspondence to the increased amount of calculations. Furthermore, in the scene-specific sliding-window method, sliding windows are generated by a person, accuracy of vehicle detection decreases. The problem becomes more serious in a case where various types of vehicles exist, that is, a case where various types of aspect ratios exist.

### SUMMARY

The inventors of the present disclosure have thoroughly researched resolutions of the above-stated problems of the methods in the related art. As a result, the inventors have found out that the main problems of the method in the related art occur, because information obtained from the partial image vary based on location, size, and shape of a vehicle. In detail, size of a sliding-window suitable for a partial image varies based on location and size of a vehicle. Furthermore, an aspect ratio of a sliding-window suitable for a partial image varies based on shape of a vehicle. However, the technical references in the related art did not take third e problems into consideration.

Therefore, the inventors of the present disclosure suggest a highly accurate method of detecting a vehicle that requires a small amount of calculations by considering location, size, and shape of the vehicle, a database structure for detecting a vehicle, and a method of establishing a database for detecting a vehicle via an automated learning process.

According to an aspect of the present invention, there is provided a method of detecting a vehicle, the method including inputting an image including at least one moving object; determining a semantic region model as information corresponding to location of the moving object and obtaining a sub-image including the moving object by using a size template determined to be applied to the semantic region model; and detecting a vehicle by matching the sub-image to information stored in a classifier.

The at least one semantic region model may be included with respect to the location of the moving object. At least two size templates may be included in the at least one semantic region model. The sub-image may be obtained with respect to all of the size templates. The detecting of the vehicle may include comparing the sub-image to the information stored in the classifier by using a linear support vector machine technique; and optimizing a result of the comparison by using a non-maximum suppression technique.

The semantic region model may be obtained by clustering features of the moving object. Here, a moving object for obtaining the features of the moving object may be an isolated moving object that does not overlap other moving objects. Furthermore, the features of the moving object may include information regarding location and a moving angle of the moving object. In this case, the semantic region model may be provided as 2-dimensional cluster information obtained by removing the information regarding the moving angle from an estimation cluster having clustered thereto the location of the moving object and the information regarding the moving angle of the moving object. To obtain a more accurate result of detecting a vehicle, the semantic region model may be provided as the 2-dimensional cluster information related to a pixel estimated as a road region. Furthermore, the clustering may be performed via a kernel density estimation.

Size of the semantic region model may be adjustable.

The size template may be obtained by clustering information regarding location and size of the moving object passing through the semantic region model.

A number of the size templates may be adjustable.

According to another aspect of the present invention, there is provided a database structure for detecting a vehicle, the database structure including a first database, in which a semantic region model may be stored in connection with pixel locations in an image as a region that a moving object may be located; and a second database, in which size templates for obtaining a sub-image of the moving object to be compared to information stored in a classifier are stored in correspondence to the semantic region model. Here, at least two size templates may be included in any one of the semantic region model.

According to another aspect of the present invention, there is provided a method of establishing a database for detecting a vehicle, the method including obtaining an image from an input video and removing the background from the image; obtaining features of a moving object by analyzing the moving object and clustering the features of the moving object; obtaining semantic region models by performing clustering until a sufficient amount of features of the moving object are obtained; and obtaining size templates to be respectively used to the corresponding semantic region models by clustering at least size information regarding the moving object passing through the respective semantic region models.

Size of the semantic region model and a number of the size templates may be adjustable.

A moving object for obtaining the features of the moving object may be an isolated moving object that does not overlap other moving objects.

The features of the moving object may include information regarding location and a moving angle of the moving object.

According to embodiments of the present disclosure, an automated method of inexpensively, quickly, and accurately detecting a vehicle with a small amount of calculations, a database structure for detecting a vehicle, and a method of establishing a database for detecting a vehicle may be provided.

### BRIEF DESCRIPTION OF THE DRAWINGS

FIG. 1 is a flowchart for describing a method of establishing a database for detecting a vehicle, according to an embodiment of the present disclosure;

FIG. 2 is a diagram showing a moving object and a trajectory of the moving object in an arbitrary image;

FIG. 3 is a diagram for describing a process for obtaining features of the moving object by analyzing the moving object;

FIG. 4 is a diagram showing an algorithm for exemplifying a process for clustering features;

FIG. 5 is a diagram showing estimated probabilities of road regions as shaded regions;

FIG. 6 is a diagram showing a semantic region model defined via the above-stated operations;

FIG. 7 is a diagram, showing semantic region models and size templates;

FIG. 8 is a diagram showing a database structure for detecting a vehicle;

FIG. 9 is a flowchart for describing a method of detecting a vehicle according to an embodiment of the present disclosure;

FIG. 10 is a diagram for describing an example of a method of detecting a vehicle according to an embodiment of the present disclosure;

FIG. 11 is a table showing an environment that a method of establishing a database for detecting a vehicle according to an embodiment of the present disclosure was simulated; and

FIG. 12 is a table showing a result of the simulation.

### DETAILED DESCRIPTION

As the present disclosure allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present invention are encompassed in the present disclosure. Furthermore, mathematical expressions or values provided in the descriptions of embodiments of the present disclosure are merely examples provided for convenience of explanation, and it is clear that the example mathematical expressions and values do not limit the present disclosure. Furthermore, cited references introduced in the description of embodiments of the present disclosure are considered as parts of the present disclosure within the scope for understanding the present disclosure.

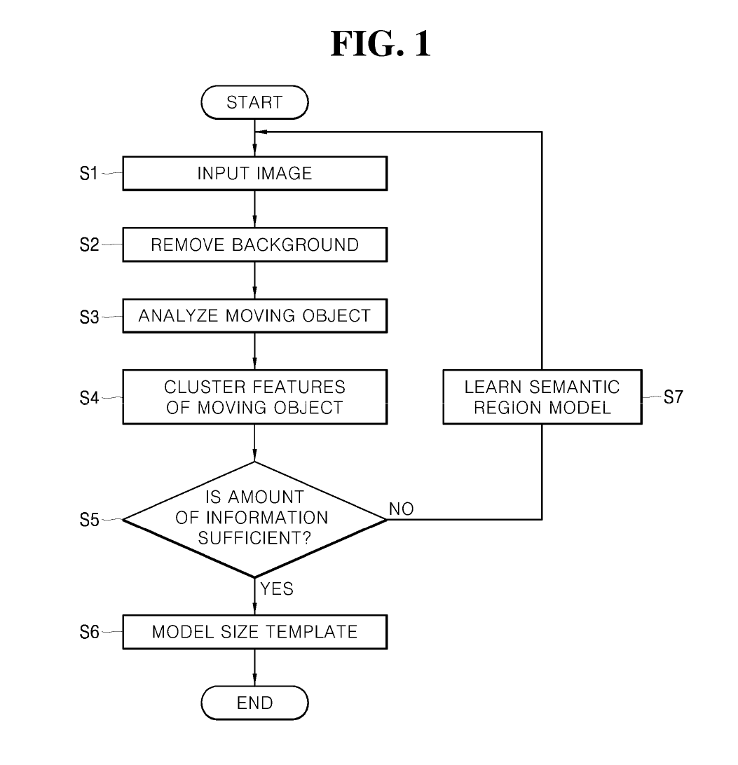

FIG. 1 is a flowchart for describing a method of establishing a database for detecting a vehicle, according to an embodiment of the present disclosure.

Referring to FIG. 1, an image corresponding to a particular time point is input from an input video (operation S1), and the background is removed from the image (operation S2). When the background is removed from an image, a moving object appears. A feature of the moving object is obtained by analyzing a motion and a position of the moving object (operation S3). Next, the feature of the moving object is clustered (operation S4). It is determined whether sufficient information is obtained via the clustering (operation S5). If information obtained via the clustering is insufficient, a semantic region model is learned (operation S7), and then a new image from the input video is input. When sufficient information is obtained, a size template for a sliding-window is modeled (operation S6).

As the method of establishing a database is performed, a semantic region model and a size template of a sliding-window that may be included in the semantic region model may be obtained.

The method of establishing a database for detecting a vehicle will be described below in closer details. The detailed descriptions thereof given below may provide example drawings, example mathematical expressions, and example numbers for describing configurations of embodiments in closer details.

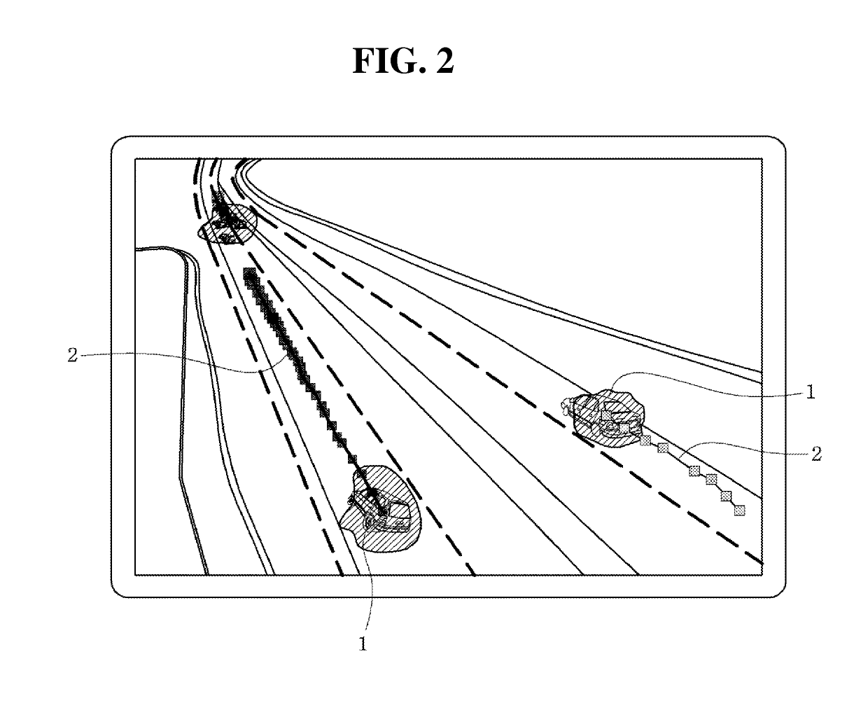

First, when an image corresponding to a particular time point included in an input video is input (the operation S1), the background is removed from the corresponding image (operation S2). When the background is removed, a moving object 1 may be detected in the image. The moving object 1 may also be referred to as a region of interest or a blob. However, the moving object 1 will be referred to as the moving object 1 below. The moving object may be provided to have clearly conspicuous boundary lines against the background via a morphology processing. In FIG. 2, a shaded region surrounding a vehicle indicates that a moving object is exposed by removing the background. For example, the background removal (operation S3) may be performed according to the method provided in “A new framework for background subtraction using multiple cues” (S. Noh and M. Jeon, Proc. ACCV, 2012).

After the moving object is identified, a motion of the moving object is analyzed, thereby obtaining features of the moving object (operation S3). It may be expected that the moving object corresponds to a vehicle. As features of the moving object, a 2-dimensional position of the moving object and a moving angle of the moving object may be given. The features of the moving object will be described below in closer details with reference to the attached drawings.

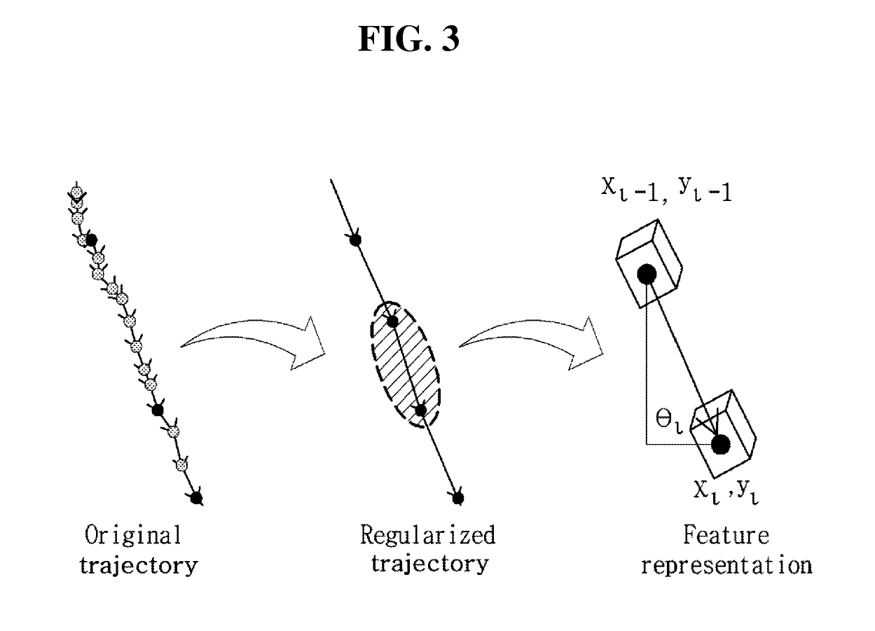

FIG. 2 is a diagram showing a moving object and a trajectory of the moving object in an arbitrary image, and FIG. 3 is a diagram for describing a process for obtaining features of the moving object by analyzing the moving object.

Referring to FIGS. 2 and 3, an arbitrary image as shown in FIG. 2 may be continuously obtained at a certain time interval and a trajectory of a certain moving object included in the arbitrary image may be indicated as shown in the left image of FIG. 3. The trajectory may be referred to as an original trajectory 2. The original trajectory 2 may be regularized to reduced errors that may occur during removal of the background. For example, a trajectory of a moving object is obtained not based on an entire obtained image, but based on a selected portion. More particularly, a time interval defined by Equation 1 below may be selected as a landmark.

p=0.06·min (W, H) [Equation 1]

where p denotes a distance between pixels of a landmark, and W and H denote width and height of an image, respectively. Therefore, an interval corresponding to a value 0.06 times value of a value smaller than the other between width and height of an image may be selected as a regularized interval of a moving object, that is, a landmark of the original trajectory of the moving object.

A regularized trajectory of the moving object is shown in the center image of FIG. 3.

A position and a moving angle of the moving object may be obtained by extracting a movement state of any one of the regularized trajectory of the moving object. Detailed descriptions thereof will be given below with reference to the right image of FIG. 3.

First, a position of the moving object may move from (xl-1, yl-1) to (xl, yl), where a moving angle may be given as θl=arctanayl-yl-1)/(xl-xl-1). The three pieces of information, that is, (xl, yl, θl) are feature of the moving object and may be used later for feature clustering.

Incidentally, only an isolated moving object that does not interfere another moving object adjacent thereto may be used as a moving object for extracting features of the moving object. In detail, in an arbitrary image, at least two vehicles running on lanes adjacent to each other may not overlap each other previously and may currently overlap each other and may be merged with each other. Alternatively, the at least one vehicles may previously overlap each other and may currently be split from each other. Here, trajectories that are merged with each other as time passes may be referred to as a merged trajectory, whereas trajectories that are split from each other may be referred to as a split trajectory.

Features of a moving object may likely be extracted inaccurately from the merged trajectory and the split trajectory due to a mergence or a split of moving objects. Therefore, a trajectory of a moving object having the merged trajectory or the split trajectory may be excluded from extraction of a trajectory. In other words, a trajectory of a moving object may be extracted from an isolated moving object trajectory. At least one two or more features may be extracted from an isolated moving object trajectory.

Next, features of the moving object are clustered (operation S4).

A kernel density estimation (KDE) may be applied for clustering the features of the moving object. In other words, the features of the moving object vl=(xl, yl, θl) may be mapped to vector components of respective axes of a 3-dimensional coordinate system. In other words, (x, y, θ) may correspond to respective axes of an xyz coordinate system. A process for estimating and clustering features of each moving object in the 3-dimensional coordinate system via a KDE may be performed.

Clustering of features of a moving object will be described in detail. Although the following clustering method does not exclude any other clustering, it is preferable since it reduces calculation to enable quick learning, does not require a large storage space, and enables accurate clustering.

First, an estimation cluster E that is estimated for clustering features of a moving object may be defined as shown in Equation 2 below.

ωk={Ck/|k=1, . . . , n ε}(where Ck=<εk, mk, Σk, Dk> [Equation 2]

where Ck denotes a k^{th} cluster at which features of a moving object are clustered, and ε denotes a set of all clusters. The Ck may vary based on four elements. In detail, from among the four elements, ωk is a scalar value denoting importance, mk denotes the center vector, Σk denotes a covariance matrix, and Dk denotes a sample storage.

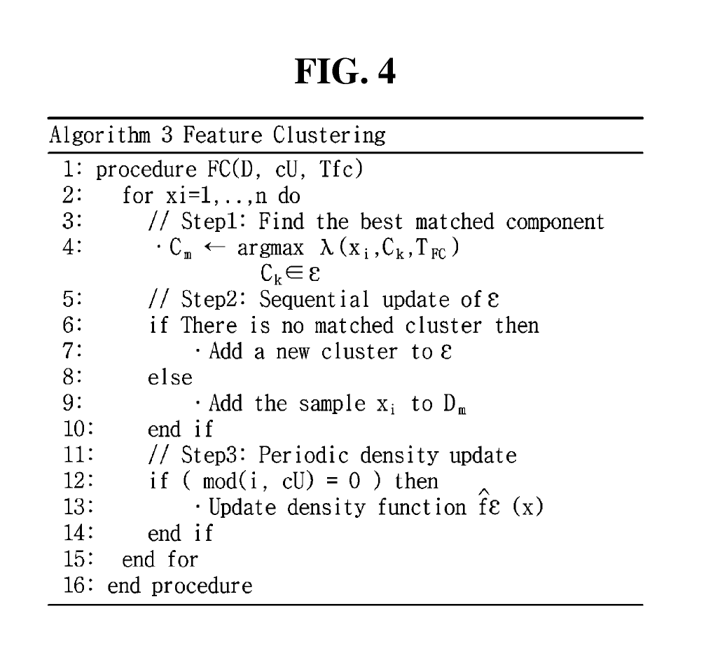

FIG. 4 is a diagram showing an algorithm for exemplifying a process for clustering features.

Referring to FIG. 4, first, data D, an update cycle cu, and a tolerance for feature clustering TFC are input for feature clustering FC (lines 1 and 2). Here, the data includes each feature vl provided by a moving object, the update cycle is a cycle for updating an elliptical cluster, and the tolerance for feature clustering is a tolerance for controlling matching of clusters. Here, as described above, the moving object may be an isolated moving object trajectory. The update cycle and the tolerance for feature clustering may be selected by an operator.

After data is input, it is determined a cluster that is the most preferably matched to certain data. If there is no cluster matched to the certain data, a new cluster is added and the data is added to the new cluster (lines 6 and 7). If there is a cluster matched to the certain data, current data is added as data Dm included in an existing cluster Cm (lines 8 and 9). A value given as the tolerance for feature clustering TFC may be referred to for determining size and shape of the new cluster and determining whether the certain data is included in the existing cluster Cm.

The above-stated operations may be repeatedly performed for a number of times corresponding to a pre-set number of pieces of data. In other words, the above-stated operations may be repeatedly performed for a number of times corresponding to a number of pieces of data given in the update cycle cu. If a number of given pieces of data is added to a cluster, shape of the cluster, which may be an elliptical shape, is updated (lines 11, 12, and 13). The shape of the cluster may be updated by using data included in a current cluster or may be updated by using any of various other techniques. For example, Equation 3 below may be applied thereto. Here, all clusters are estimation clusters and may be changed via learning.

$${ɛ}_{k} = \frac{1}{1 + exp ( - 10 \cdot ( \frac{\vert {D}_{k} \vert}{5 d} - 0.6 ) )} \qquad [ Equation 3 ]$$

Referring to Equation 3 and Equation 2, as a number of pieces of data matched to the sample storage Dk increases toward 5d, the importance ωk increases from 0 to 1 and is always regularized. Here, d denotes dimension of the covariance matrix Σk. Furthermore, after the estimation cluster is updated, the sample storage Dk is cleared and new data is stored therein.

The above-stated operations are performed with respect to all data (lines 2, 14, 15, and 16).

After the clustering (operation S4) with respect to features of a moving object is completed via the above-stated operations, a 3-dimensional coordinate system having clustered all features thereto may be provided. In other words, clustered features vl of a moving object may be indicated at a 3-dimensional coordinate system having (x, y, θ) axes, and thus the estimation cluster may be completed.

Next, it is determined whether sufficient amount of data is clustered (operation S5). It may be determined whether sufficient amount of data is clustered based on the number of the isolated moving object trajectories. Based on a result of an experiment, detection of a vehicle could not be correctly performed with the 82 isolated moving object trajectories, and detection of a vehicle could be correctly performed with the 120 isolated moving object trajectories. Therefore, if 100 or more pieces of feature information regarding moving objects are included as the isolated moving object trajectories, it may be considered that sufficient amount of information is included.

If it is determined that insufficient amount of data is clustered, the semantic region model 3 is learned (operation S7) and, when it is determined that sufficient amount of data is clustered, a size template regarding a window is modeled (operation S8).

First, the operation S7 for learning the semantic region model will be described below. The learning of the semantic region model may include estimation of a road region, comparison of the estimated road region to the estimation cluster, and determination of a portion of the estimation cluster overlapping the road region as the semantic region model. Physically speaking, an environment surrounding a closed-circuit TV may be an outside environment with strong winds. Therefore, even if a vehicle runs on a correct road, a camera may be shaken by winds, and thus the estimation cluster may become incorrect. In other words, an incorrect estimation cluster may be generated. Therefore, to remove such an error, a region of an estimation cluster corresponding to occurrences of features of a moving object equal to or greater than a certain degree may be estimated as a road, and regions of the estimation cluster outside the region estimated as a road may be excluded from a semantic region model. Therefore, at a location without a wind or a location with few possible errors, the operation S7 for estimating a road region, determining whether the road region overlaps the estimation cluster, and learning a semantic region model may not be performed. Here, 2-dimensional information obtained by removing angle information from the estimation cluster may be used as a semantic region model.

An operation for estimating the road region will be described below.

An estimation cluster completed in the 3-dimensional coordinate system having (x, y, θ) axes will be denoted as εv, where a 2-dimensionally indicated estimation cluster obtained by removing the 0 component therefrom will be denoted as εᵥ^{s} and provided. The estimation cluster is processed to 2-dimensional information, because the road region is 2-dimensionally displayed. In the same regard, the center vector may be denoted as mₖ^{s}, and the covariance matrix may be denoted as Σₖ^{s}. Therefore, εᵥ^{s} may be expressed as εᵥ^{s}={Cₖ₌₁^{s}, . . . n_{ε}}, where Cₖ^{s} includes information regarding the center vector mₖ^{s}, the covariance matrix Σₖ^{s}, and the importance ωk. As a result, a probability that a vehicle is located at a current 2-dimensionally displayed pixel r=(x,y) may be expressed as shown in Equation 4 below.

$$\hat{f} ( r \vert {ɛ}_{v}^{s} ) = \frac{1}{2 π} {\sum }_{k = 1}^{{n}_{ɛ}} \frac{{ω}_{k}}{\vert {\sum }_{k}^{s} \vert 1 / 2} exp ( - \frac{D ( r ; {m}_{k}^{s} , {\sum }_{k}^{s} )}{2} ) \qquad [ Equation 4 ]$$

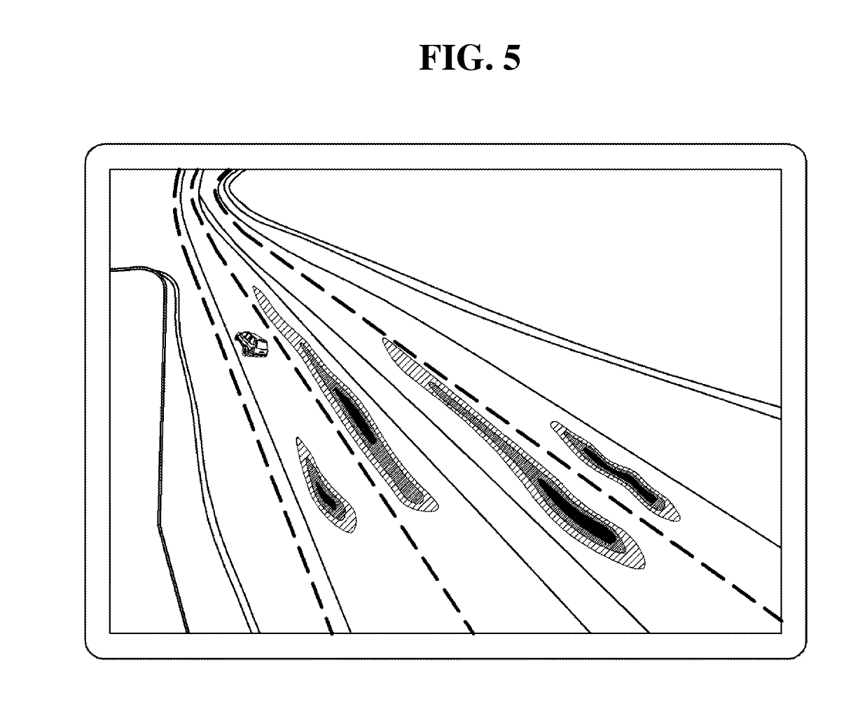

FIG. 5 is a diagram showing probabilities of road regions as defined by Equation 4. Referring to FIG. 5, it may be understood that brighter regions may more likely be road regions.

In the probability distribution, a pixel satisfying Equation 5 below may be confirmed as a road region.

$$\hat{f} ( r \vert {ɛ}_{v}^{s} ) \geq 0.5 \cdot {{min}_{k = 1}}^{{n}_{ɛ}} {η}_{k}^{s} \qquad [ Equation 5 ]$$

where ηₖ^{s} denotes a peak probability in a regular distribution having the center vector mₖ^{s} and the covariance matrix Σₖ^{s}. A road region may be estimated by using a criteria for determination given in Equation 5 above.

After the road region is estimated, an operation for configuring the semantic region model (SRM) is performed.

The 2-dimensionally displayed estimation cluster related to the pixel estimated as the road region may be defined as a semantic region model SRM. In other words, a 2-dimensional estimation cluster determined to be included in the pixel estimated as the road region may be defined as a semantic region model SRM 3. In detail, a 2-dimensional estimation cluster satisfying Equation 6 may be defined as a semantic region model.

N(r_{R}; mₖ^{s}, Σₖ^{s})≧0.3·ηₖ^{s} [Equation 6]

where N denotes a bivariate normal density function.

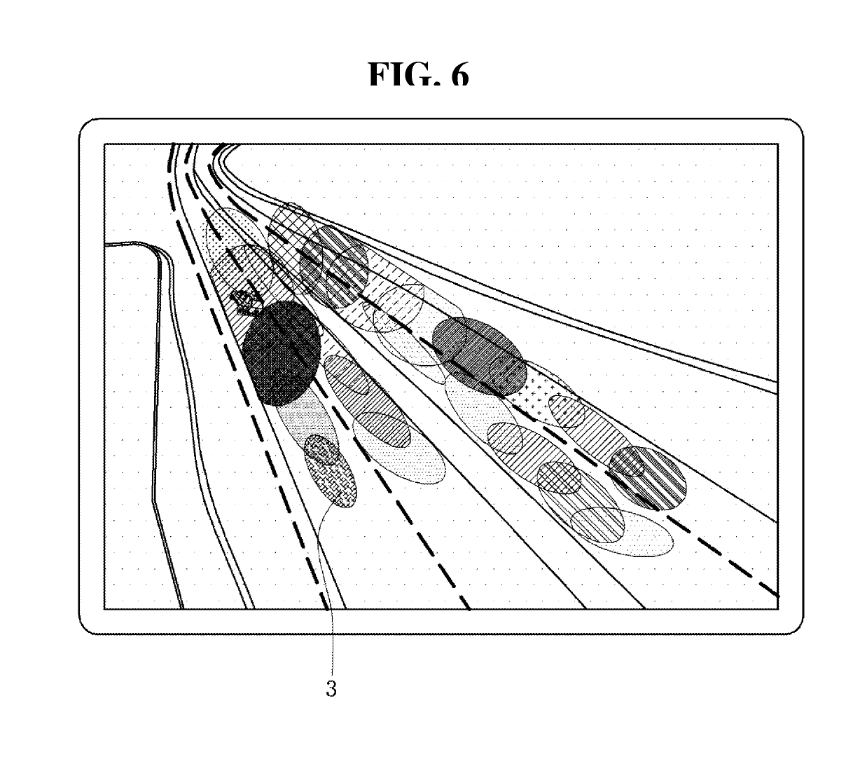

FIG. 6 is a diagram showing a semantic region model defined via the above-stated operations.

Referring to FIG. 6, the semantic region models SRM may be provided to overlap one another. Two lanes far from a closed-circuit TV may not be distinguished from each other, whereas two lanes close to the closed-circuit TV may be separated from each other. Each semantic region model may have its own 2-dimensional region distinguishable from other boundary lines. It may be understood that the semantic region models are related to probabilities of vehicle existences.

If it is determined that sufficient amount of information is collected in the operation S5 for determining whether sufficient amount of information is collected, size templates 4 are modeled. The size template models may be provided to be suitable for the respective semantic region models. For example, a small size template may be provided with respect to a semantic region model far from the closed-circuit TV in consideration of small size of a vehicle.

A process for providing the size templates will be described below in closer details.

For convenience of explanation, a drawing in which the isolated moving object trajectories overlap the semantic region models. For example, it may be considered that the trajectories shown in FIG. 2 may overlap the semantic region models shown in FIG. 6. In this case, moving objects provided in the isolated moving object trajectories may be included in at least one or, preferably, all semantic region models on the isolated moving object trajectories.

In each image, each moving object is separated from the background via boundary lines and may have position information and size information, e.g., information (x, y, w, h). The information may be learned via a clustering algorithm. A basic sequential algorithmic scheme (BSAS) may be applied as the clustering algorithm. More particularly, the algorithm disclosed in the “Sequential clustering algorithms” (S. Theodoridis and K. Koutrombas, Pattern recognition, pp.633-643, 2008) may be applied as the clustering algorithm.

The clustering algorithm will be briefly described below.

A difference between size information regarding a current moving object and size information regarding a stored size template is obtained. If the difference is equal to or greater than a certain degree, a new size template may be generated. If the difference is smaller than or equal to the certain degree, the stored size template may be used to represent the size information regarding the current moving object without changing the stored size template.

If the certain degree is referred to as TBSAS, as a value of TBSAS decreases, more various size templates may be obtained and a more accurate vehicle detection result may be obtained, where an amount of calculations therefor and a time elapsed for the calculations may increase. In the same regard, as the tolerance for feature clustering TFC increase, size of the semantic region model 3 increases and more size templates may be obtained, and thus a more accurate vehicle detection result may be obtained. However, an amount of calculations therefor and a time elapsed for the calculations may increase. Therefore, the tolerances TBSAS and TFC may vary based on specific circumstances.

Via the learning operation, a plurality of size templates that may be included in any one semantic region model may be provided. Here, a size template suitable for any one semantic region model may be generated in match with any one of the semantic region model. Therefore, since a vehicle is displayed small in a semantic region model far from a closed-circuit TV, a relatively small size template may be provided. Size templates of different sizes and shapes may be obtained with respect to a same vehicle as an angle between a closed-circuit TV and the vehicle is changed or based on a distance between the closed-circuit TV and the vehicle. For example, various size templates, such as a rectangular size template with longer width-wise sides, a rectangular size template with longer height-wise sizes, and a square size template, may be obtained with respect to a same vehicle. The size templates 4 obtained in various shapes as described above are matched to the respective semantic region models 3, and thus each of the size templates 4 may best reflect information related to a location thereof. In other words, it may be understood that the size template is related to size of a window that may be suitably used within a certain semantic region model.

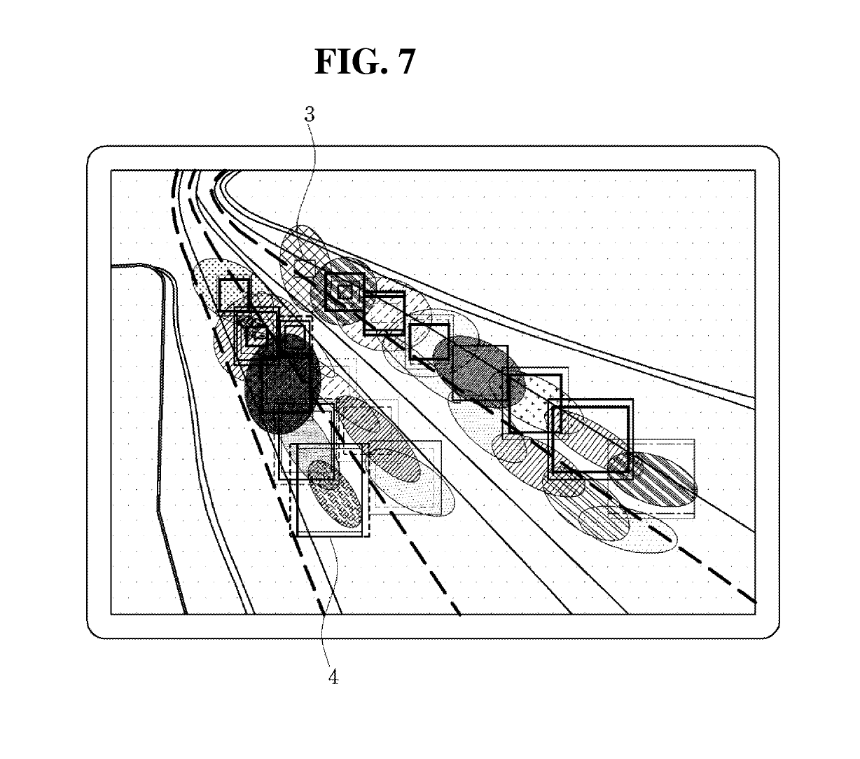

FIG. 7 is a diagram, showing semantic region models and size templates.

Referring to FIG. 7, size templates of various sizes and shapes are allocated to semantic region models.

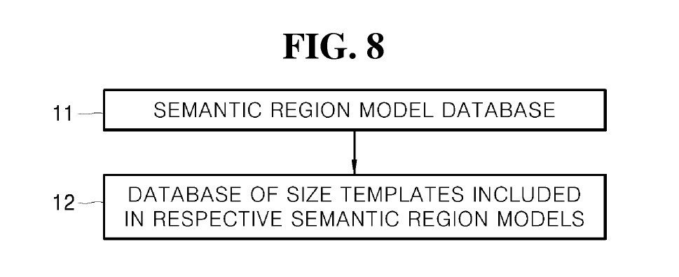

FIG. 8 is a diagram showing a database structure for detecting a vehicle.

Referring to FIG. 8, as a result of performing the method of establishing a database for detecting a vehicle as shown in FIG. 1, two different types of databases may be obtained. In detail, a first database 11 having storing the semantic region models and a second database 12 storing the size templates may be obtained. The semantic region models stored in the first database 11 may be stored in connection with pixel locations in an image. In other words, the semantic region models may be designated based on pixel locations in the image. Size templates stored in the second database 12 may be stored to be able to identify semantic region models to apply the respective size templates to. Although the first database 11 and the second database 12 may be stored in actually distinguished locations, different types of information may be stored based on a certain relationship therebetween. The certain relationship may be understood that size templates matched to a certain semantic region model are identified and stored.

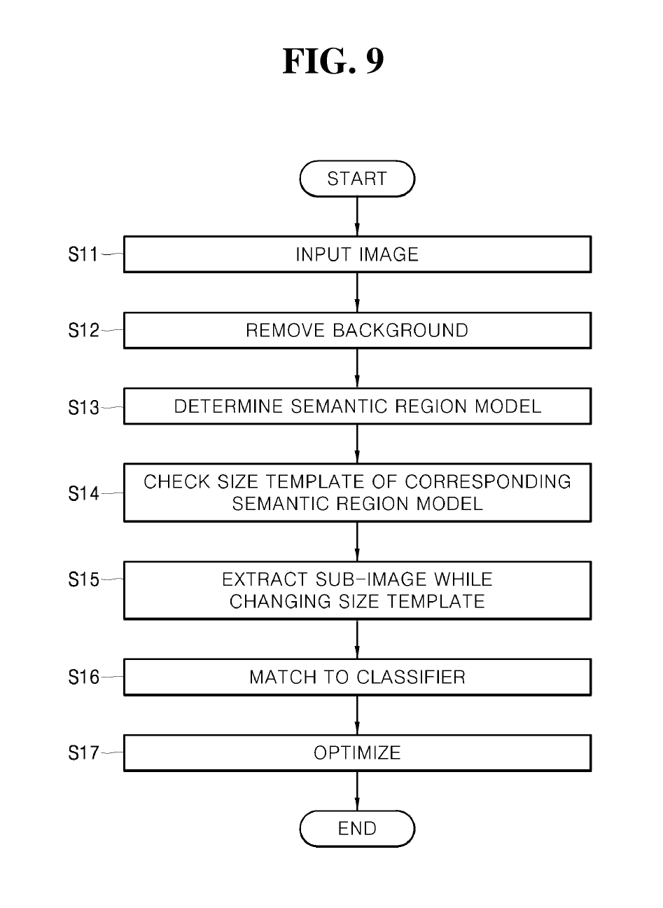

FIG. 9 is a flowchart for describing a method of detecting a vehicle according to an embodiment of the present disclosure.

Referring to FIG. 9, the method of detecting a vehicle according to an embodiment of the present disclosure is performed by using a database structure for detecting a vehicle. Furthermore, since some of the operations performed in the method of establishing a database for detecting a vehicle are also applied, detailed descriptions of the corresponding operations will be applied to the description of the method of detecting a vehicle.

First, an image is input (operation S11). The image may be provided as an image corresponding to a particular time point from an input video including a vehicle. Next, the background is removed via a background removing operation, and a moving object may appear as a region distinguishable from the background (operation S12). When the moving object appears, a semantic region model SRM 3 corresponding to location of the moving object is determined (operation S13). Here, one, two, or more semantic region models may be included at a location of any one moving object. The semantic region model 3 may be stored in the database structure for detecting a vehicle and read out. The reason thereof is that a trajectory of a moving object is clustered to a 3-dimensional system also including a moving angle θ. Next, a size template 4 determined to be used with respect to the determined semantic region model 3 is checked (operation S14). The size template 4 may be stored in the database structure for detecting a vehicle and read out.

Next, a sub-image of the moving object distinguished in the background removing operation S12 is obtained by using the size template 4 determined in the size template determining operation S14 as a window (operation S15). In the sub-image obtaining operation S15, a sub-image of the moving object is obtained by using at least one or, preferably, all size templates determined in the size template determining operation S14. Therefore, at least one sub-image may be obtained. In other words, at least one sub-image suitable for a current location and a vehicle may be obtained by using various size templates suitable for any one of the semantic region models as windows.

When the sub-image is obtained, the sub-image is matched and compared to information stored in a classifier (operation S16). The classifier stores all images as images of a certain size designated by an operator (square images of 48×48 size according to an embodiment of the present disclosure). Therefore, a sub-image obtained by using the size template may be deformed to have a size corresponding to that of images stored in the classifier (square images of 48×48 size according to an embodiment of the present disclosure), and then information included in the deformed sub-image may be compared to information included in the images stored in the classifier. The comparison between information included in the sub-image and information included in the images stored in the classifier may be performed by applying a linear support vector machine technique thereto, for example. The disclosure of the “Finding People in Images and Videos” (N. Dalal, Ph.D. thesis, Institute National Polytechnique de Grenoble, 2006) may be referred to for detailed descriptions of the comparison.

Next, a result of the comparison is optimized and a vehicle is finally detected (operation S17). Detection of a vehicle may be performed by applying a non-maximum suppression technique thereto. The non-maximum suppression technique may be the technique disclosed in the “Finding People in Images and Videos” (N. Dalai, Ph.D. thesis, Institute National Polytechnique de Grenoble, 2006).

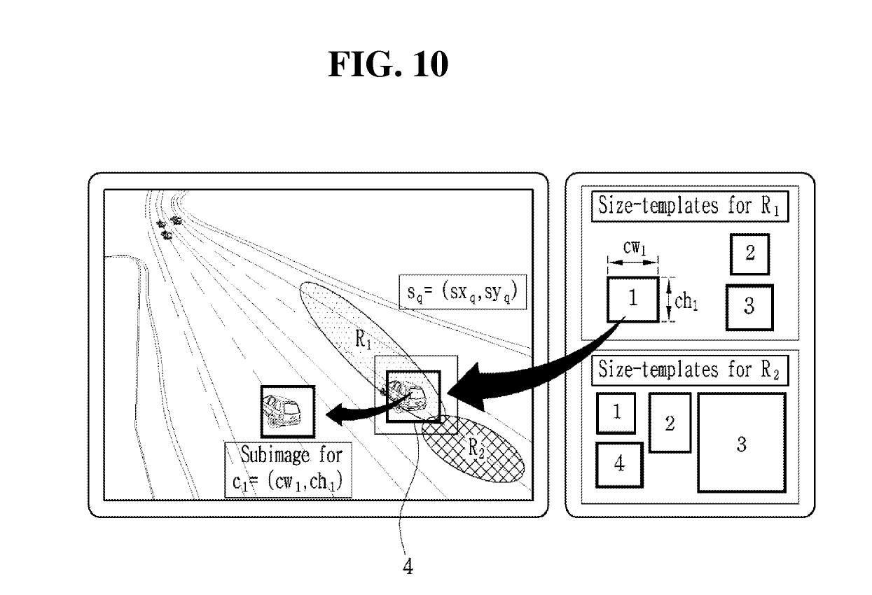

FIG. 10 is a diagram for describing an example of a method of detecting a vehicle according to an embodiment of the present disclosure.

Referring to FIG. 10, when a moving object is detected in an image, a location R1 of the moving object is determined. At least one of provided size templates 4 is applied to the location R1 of the moving object, and thus at least one sub-image is read out. The sub-image may be compared to information stored in a classifier, and thus a vehicle may be detected.

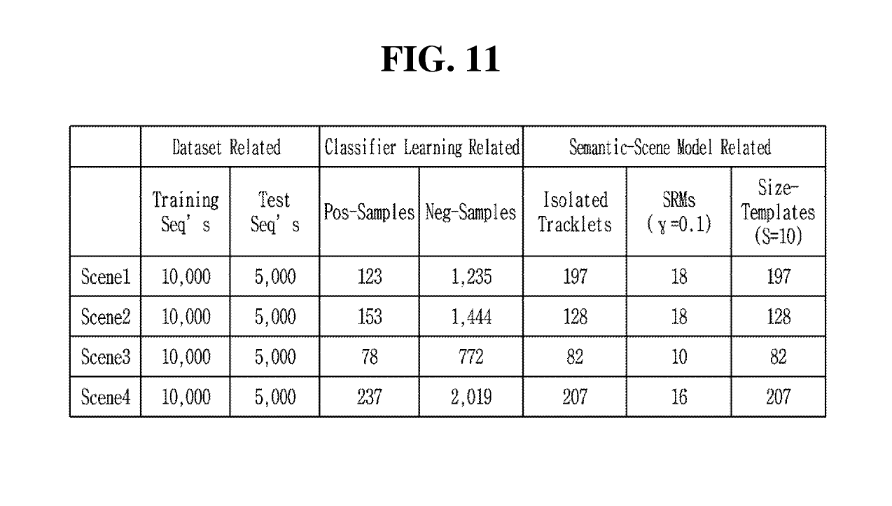

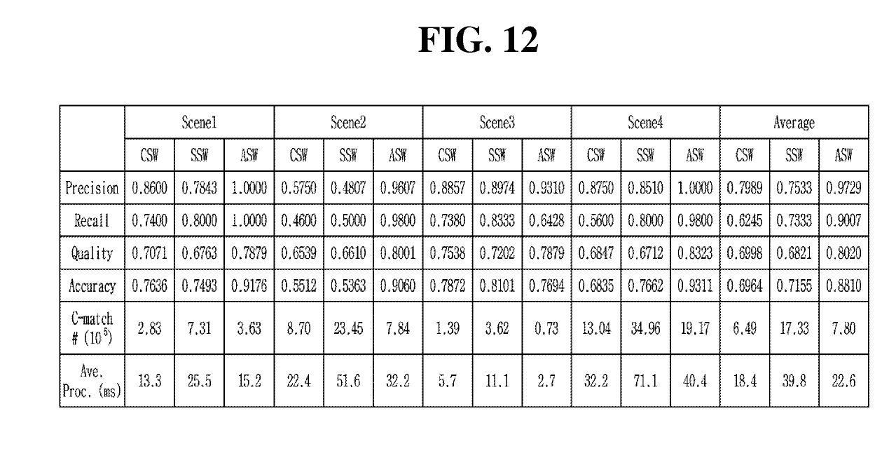

FIG. 11 is a table showing an environment that a method of establishing a database for detecting a vehicle according to an embodiment of the present disclosure was simulated, and FIG. 12 is a table showing a result of the simulation.

Referring to FIG. 11, a data set for simulation was established with respect to each of four scenes. Each data set included 10,000 learning image sequences and 5,000 test image sequences of 760×570 size. Learning of a classifier and collection of isolated moving object trajectories to be applied to each scene were performed by using the 10,000 learning images. The learning of the classifier was performed by using the methodology disclosed in the “Large-scale vehicle detection, indexing, and search in urban surveillance videos” (R. Feris, B. Siddiquie, J. Petterson, Y. Zhai, A. Datta, L. Brown, and S. Pankanti, Tran. Multimedia, Vol.14, pp.28-42, 2012). A tolerance for feature clustering TFC was modeled to <yW, yH, n/8>, where y was set to 0.1 based on a simulation. Incidentally, the tolerance TBSAS was modeled to <τS, τS>, where τS was set to 10 based on a simulation.

Results of testing a classical sliding-window (CSW) method, a scene-specific sliding-window (SCW) method, and the method according to an embodiment of the present disclosure under each of the simulation environments are shown in FIG. 12 for performance comparison.

Referring to FIG. 12, referring to an average performance, although the classical sliding-window (CSW) method exhibited a very fast operation speed, the classical sliding-window (CSW) method showed too low vehicle detection accuracy, and thus it was difficult to apply the classical sliding-window (CSW) method to an actual application system. Furthermore, although the scene-specific sliding-window (SCW) method exhibited accuracy about 2.7% higher than that of the classical sliding-window (CSW) method, the accuracy was still too low to apply the scene-specific sliding-window (SCW) method to an actual application system. Furthermore, another problem was that an amount of calculations required by the scene-specific sliding-window (SCW) method is 2.16 times greater than that required by the classical sliding-window (CSW) method.

As compared to the classical sliding-window (CSW) method, the method according to an embodiment of the present disclosure exhibited accuracy improved by 26% or more based on an amount of calculations that is only 1.2 times greater.

In case of the scene 3, the method according to an embodiment of the present disclosure exhibited lower accuracy compared to the other methods. However, the reason thereof was that, since a number of learning image sequences was limited to 10,000 for simulation, only an insufficient number (that is, 82) of isolated moving object trajectories were used for learning semantic region models and size templates. Therefore, it is obvious that the problem may be naturally resolved by collecting a sufficient number of isolated moving object trajectories for a sufficient time period.

According to the present disclosure, since all operations are automatically performed except that information is manually stored in a classifier by an operator, the operations may be performed inexpensively and a vehicle may be quickly and accurately detected with a small amount of calculations. Furthermore, the present disclosure may be applied to development of an application for counting a number of passing vehicles in a screen image and analyzing volume of traffic of a corresponding traffic scene

What is claimed is:

1. A method of detecting a vehicle, the method comprising:
inputting an image including at least one moving object;
determining a semantic region model as information corresponding to location of the moving object and obtaining a sub-image including the moving object by using a size template determined to be applied to the semantic region model; and
detecting a vehicle by matching the sub-image to information stored in a classifier.

2. The method of claim 1, wherein the at least one semantic region model is included with respect to the location of the moving object.

3. The method of claim 1, wherein at least two size templates are included in the at least one semantic region model.

4. The method of claim 1, wherein the sub-image is obtained with respect to all of the size templates.

5. The method of claim 1, wherein the detecting of the vehicle comprises:
comparing the sub-image to the information stored in the classifier by using a linear support vector machine technique; and
optimizing a result of the comparison by using a non-maximum suppression technique.

6. The method of claim 1, wherein the semantic region model is obtained by clustering features of the moving object.

7. The method of claim 1, wherein a moving object for obtaining the features of the moving object is an isolated moving object that does not overlap other moving objects.

8. The method of claim 6, wherein the features of the moving object comprise information regarding location and a moving angle of the moving object.

9. The method of claim 8, wherein the semantic region model is a 2-dimensional cluster information obtained by removing the information regarding the moving angle from an estimation cluster having clustered thereto the location of the moving object and the information regarding the moving angle of the moving object.

10. The method of claim 9, wherein the semantic region model is the 2-dimensional cluster information related to a pixel estimated as a road region.

11. The method of claim 6, wherein the clustering is performed via a kernel density estimation.

12. The method of claim 1, wherein size of the semantic region model is adjustable.

13. The method of claim 1, wherein the size template is obtained by clustering information regarding location and size of the moving object passing through the semantic region model.

14. The method of claim 1, wherein a number of the size templates is adjustable.

15. A database structure for detecting a vehicle, the database structure comprising:
a first database, in which a semantic region model is stored in connection with pixel locations in an image as a region that a moving object is located; and
a second database, in which size templates for obtaining a sub-image of the moving object to be compared to information stored in a classifier are stored in correspondence to the semantic region model.

16. The database structure of claim 15, wherein at least two size templates are included in the semantic region model.

17. A method of establishing a database for detecting a vehicle, the method comprising:
obtaining an image from an input video and removing the background from the image;
obtaining features of a moving object by analyzing the moving object and clustering the features of the moving object;
obtaining semantic region models by performing clustering until a sufficient amount of features of the moving object are obtained; and
obtaining size templates to be respectively used to the corresponding semantic region models by clustering at least size information regarding the moving object passing through the respective semantic region models.

18. The method of claim 17, wherein size of the semantic region model and a number of the size templates are adjustable.

19. The method of claim 17, wherein a moving object for obtaining the features of the moving object is an isolated moving object that does not overlap other moving objects.

20. The method of claim 17, wherein the features of the moving object comprise information regarding location and a moving angle of the moving object.
